(19) United States
(12) Patent Application Publication
(10) Pub. No.: US 2026/0156177 A1
(43) Pub. Date: Jun. 4, 2026

(54) OPTIMIZING TOTAL COST OF OWNERSHIP FOR ADAPTIVE DATA WAREHOUSING SYSTEMS

(71) Applicant: SAP SE, Walldorf (DE)

(72) Inventors: Krishnan Raghupathi, Bangalore (IN); Vikash Sadangi, Bangalore (IN)

(21) Appl. No.: 18/965,775

(22) Filed: Dec. 2, 2024

(51) Int. Cl. H04L 67/1031; G06N 20/00

(52) U.S. Cl. CPC H04L 67/1031; G06N 20/00

(57) ABSTRACT

A system includes an abstraction layer, a serverless service, and a predictive auto-scaling resource adviser coupled to the serverless service. The predictive auto-scaling resource adviser automatically scales the serverless service by adding or removing compute nodes based on computational needs of one or more planned workloads. Accordingly, the predictive auto-scaling resource adviser trains a first machine learning model to predict a first amount of computational resources expected to be utilized by a first client. Next, the predictive auto-scaling resource adviser activates a first plurality of compute nodes based on the prediction of the first amount of computational resources expected to be utilized by the first client for a first workload. Then, after activation, the system executes, with the first plurality of compute nodes, the first workload of the first client.

### TECHNICAL FIELD

The present disclosure generally relates to optimizing total cost of ownership for adaptive data warehousing systems.

### BACKGROUND

Data warehousing solutions focus on gathering information from various information sources and on providing tools for analyzing the gathered data. One key challenge, especially for customers of data warehousing systems, has been related to the total cost of ownership (TCO) of the cloud-based systems. Over the last decade, enterprise customers across all domains have made significant investments in cloud-based software systems to take advantage of the obvious benefits that such systems offer. However, the cloud journey for most customers has not been a smooth one as it has been filled with numerous challenges. Although TCO is one of the benefits cloud-based software systems claim to offer, TCO can actually be a major deterrent for customers wanting to use cloud-based data warehousing systems.

### SUMMARY

In some implementations, a system includes an abstraction layer, a serverless service, and a predictive auto-scaling resource adviser coupled to the serverless service. The predictive auto-scaling resource adviser automatically scales the serverless service by adding or removing compute nodes based on computational needs of one or more planned workloads. Accordingly, the predictive auto-scaling resource adviser trains a first machine learning model to predict a first amount of computational resources expected to be utilized by a first client. Next, the predictive auto-scaling resource adviser activates a first plurality of compute nodes based on the prediction of the first amount of computational resources expected to be utilized by the first client for a first workload. Then, after activation, the system executes, with the first plurality of compute nodes, the first workload of the first client.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a logical diagram of an example of a system, in accordance with some example implementations of the current subject matter;

FIG. 2 illustrates a block diagram of an example of a data warehouse system, in accordance with some example implementations of the current subject matter;

FIG. 3 illustrates an example of a system supporting a serverless service, in accordance with some example implementations of the current subject matter;

FIG. 4 illustrates the scaling of compute resources in the database processing layer, in accordance with some example implementations of the current subject matter;

FIG. 5 illustrates an example of a compute server, in accordance with some example implementations of the current subject matter;

FIG. 6 illustrates a process for predicting in advance the computational and resource needs of a client, in accordance with some example implementations of the current subject matter;

FIG. 7 illustrates a process for generating recommendations for scheduling the execution of serverless server workloads in order to optimize total cost of ownership, in accordance with some example implementations of the current subject matter;

FIG. 8 illustrates a system for implementing one or more machine learning models, in accordance with some example implementations of the current subject matter;

FIG. 9A depicts an example of a system, in accordance with some example implementations of the current subject matter; and

FIG. 9B depicts another example of a system, in accordance with some example implementations of the current subject matter.

### DETAILED DESCRIPTION

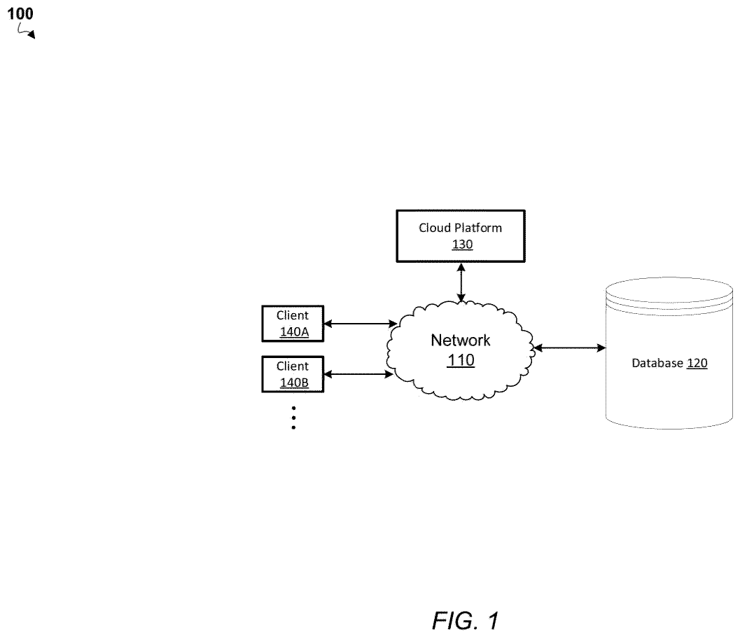

Referring now to FIG. 1, a diagram illustrating an example of a system 100 is depicted, consistent with implementations of the current subject matter. As shown in FIG. 1, the system 100 may include a cloud platform 130, and cloud platform 130 may provide resources that can be shared among a plurality of tenants. For example, the cloud platform 130 may be configured to provide a variety of services including, for example, software-as-a-service (SaaS), platform-as-a-service (PaaS), infrastructure as a service (IaaS), and/or the like, and these services can be accessed by one or more tenants of the cloud platform 130. In the example of FIG. 1, the system 100 includes a first tenant 140A (labeled client) and a second tenant 140B (labeled client as well), although system 100 may include any number of other tenants. For example, multitenancy enables multiple end-user devices (e.g., a computer including an application) as well as multiple subscribing customers having their own group of end-users with an isolated context of particular customers to access a given cloud service having shared resources via the Internet and/or other type of network 110 or communication link(s). Each tenant 140A-140B may include any number of processor-based computing devices including, for example, a desktop computer, a laptop, a smartphone, a tablet computer, a wearable apparatus, a virtual assistant, an Internet-of-Things (IoT) appliance or IoT device, and/or the like.

The cloud platform 130 may include resources, such as at least one computer (e.g., a server), data storage, and a network (including network equipment) that couples the computer(s) and storage. The cloud platform 130 may also include other resources, such as operating systems, hypervisors, and/or other resources, to virtualize physical resources (e.g., via virtual machines) and provide deployment (e.g., via containers) of applications (which provide services, for example, on the cloud platform, and other resources). In the case of cloud platform 130 including and/or being coupled to a “public” cloud platform, the services may be provided on-demand to a client, or tenant, via the Internet. For example, the resources at the public cloud platform may be operated and/or owned by a cloud service provider (e.g., Amazon Web Services, Azure), such that the physical resources at the cloud service provider can be shared by a plurality of tenants. Alternatively, or additionally, the cloud platform 130 may include and/or be coupled to one or more local servers, in which case some of the resources utilized by clients 140A-140B may be hosted on an entity's own private servers (e.g., dedicated corporate servers operated and/or owned by the entity). Alternatively, or additionally, the cloud platform 130 may be considered a “hybrid” platform, which includes and/or is coupled to a combination of on-premises resources as well as resources hosted by a public or private cloud platform. For example, a hybrid platform may include web servers running in a public cloud while application servers and/or databases are hosted on premise (e.g., at an area controlled or operated by the entity, such as a corporate entity).

In various embodiments, the cloud platform 130 provides services to client 140A-B. Each service may be deployed via a container, which provides a package or bundle of software, libraries, and configuration data to enable the cloud platform to deploy during runtime the service to, for example, one or more virtual machines that provide the service to client 140A. The service may also include logic (e.g., instructions that provide one or more steps of a process) and an interface. The interface may be implemented as an Open Data Protocol (OData) interface (e.g., HTTP message may be used to create a query to a resource identified via a URI), although the interface may be implemented with other types of protocols including those in accordance with REST (Representational state transfer). In the example of FIG. 1, an external REST type call may be used to send queries and receive responses from database 120.

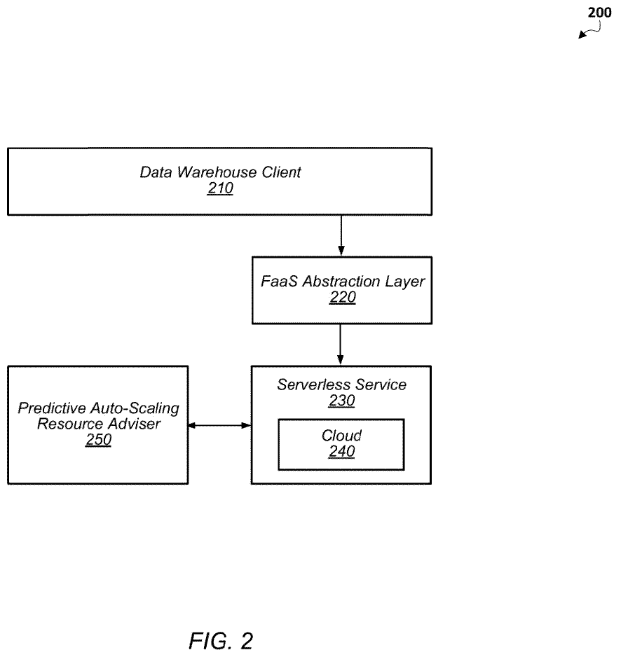

Turning now to FIG. 2, an example of a data warehouse system 200 is depicted, in accordance with one or more embodiments of the current subject matter. In an example, data warehouse system 200 includes data warehouse client 210, function as a service (FaaS) abstraction layer 220, serverless service 230, cloud resources 240, and predictive auto-scaling resource adviser 250. Data warehouse client 210 is representative of any number of clients of data warehouse system 200. Data warehouse client 210 may utilize one or more computing devices such as a desktop computer, a laptop, a smartphone, a tablet computer, a wearable apparatus, a virtual assistant, an Internet-of-Things (IoT) appliance or IoT device, and/or the like. FaaS abstraction layer 220 provides an abstraction layer that allows data warehouse client application developers to focus on developing application functionality without having to consider backend infrastructure or server configurations. It is noted that the terms “abstraction layer” and “abstractor” may be used interchangeably herein. Predictive auto-scaling resource adviser 250 automatically scales the serverless service 230 by adding and/or removing elastic compute nodes based on the computational needs of the planned workloads in the system 200.

Serverless service 230 wraps the cloud resources 240 in a serverless service abstraction. As used herein, the term “serverless service” may be defined as any serverless cloud computing execution model in which a cloud platform runs a server and dynamically manages allocation of a machine resources. Pricing of the serverless service 230 may be based on the actual amount of resources consumed by an application instead of pre-purchased units of capacity.

In an example, FaaS abstraction layer 220 implements an event-driven computing architecture to provide a service platform that abstracts any infrastructure requirement. In this approach, developers will continue to create the application logic, but the code would be executed within the context of a stateless compute instance like the SAP HANA serverless service as available from SAP SE, Walldorf, Germany. FaaS abstraction layer 220 allows developers to focus on developing the application functionality without having to factor in backend infrastructure or availability of servers. Instead, an application developer would simply need to carry out the following steps: (1) Choose the desired programming language. (2) Implement the application logic within the function. (3) Package the function along with all its dependencies. (4) Deploy the function.

Since microservices can significantly benefit from FaaS, the data warehouse client applications may be broken down into separate services that run as FaaS functions. In summary, the FaaS abstraction layer 220 provides the following key benefits: (1) Since the FaaS service model is based on a pay-as-you-go model, clients only need to pay when the function is executed which leads to a significant reduction in operational expenses. (2) Allows multiple functions to be deployed to meet diverse needs without having to change the application functionality. (3) Allows the rapid development and deployment of the required functional components without having to develop complete applications.

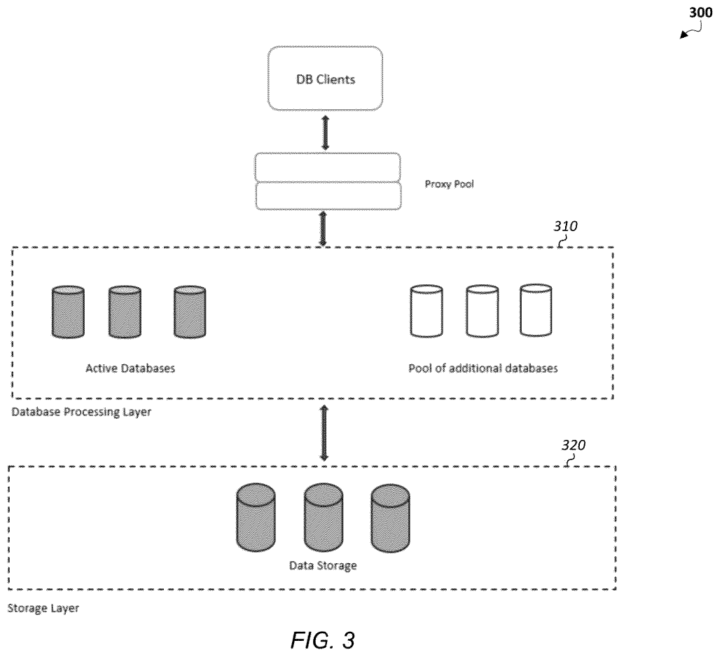

Referring now to FIG. 3, an example of a system 300 supporting a serverless service is depicted, in accordance with one or more embodiments of the current subject matter. The HANA serverless service abstracts the HANA database into a serverless service by decoupling the storage layer 320 from the database processing layer 310 that is responsible for query execution. Effectively the service allows the database to be treated as an infinitely large repository where data can be stored, manipulated, and retrieved. Application logic may access the database through an application programming interface (API)-like interface that routes the commands to the correct components automatically. The serverless service is responsible for scaling out the database processing and storage layers based on demand.

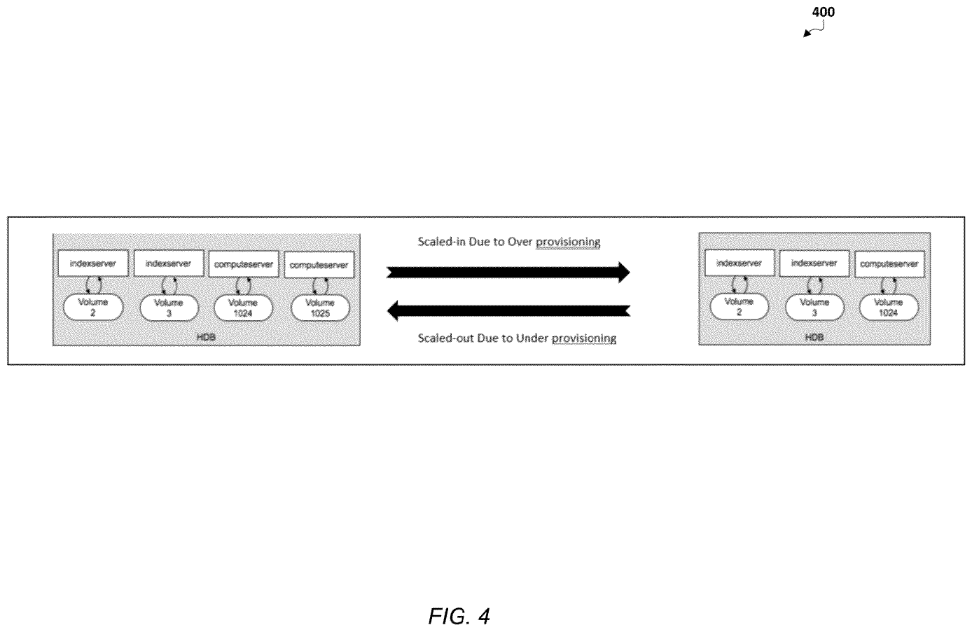

Referring now to FIG. 4, an example of scaling compute resources in the database processing layer 400 is depicted, in accordance with one or more embodiments of the current subject matter. The scaling of the database processing layer is achieved by adding or removing compute servers (e.g., Elastic Compute Nodes) as depicted in the diagram of FIG. 4. In an example, sophisticated regression models for predicting resource demand along with access to cheap cloud computing resources allows for the development and deployment of trained regression models that can predict resource requirements of memory and central processing unit (CPU) intensive workloads with a high degree of accuracy. The trained ML models may be used to accurately predict the resource requirements of scheduled workloads in data warehousing systems. Accordingly, significant reduction in the total cost of ownership of data warehousing systems can be achieved by bringing up the database servers on demand and scaling up the compute resources based on the predicted workload.

In an example, ML models may be designed and developed that can accurately predict the resource requirements (e.g., CPU, memory) of the scheduled workloads in data warehousing systems. The data warehousing systems may have the ability to automatically scale-in and scale-out the compute resources as per the predicted workload. Also, these systems may have the ability to bring up the database servers on demand as opposed to having the database servers always running.

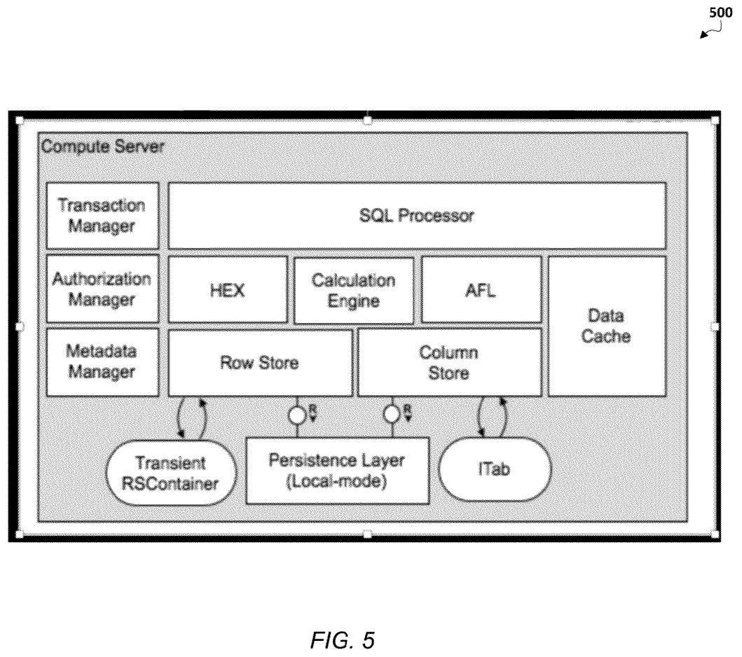

Turning now to FIG. 5, an example of a compute server 500 is depicted, in accordance with one or more embodiments of the current subject matter. Compute server 500 is a HANA service that is used for elastic scaling of compute resources for HANA databases. It is noted that the example of compute servers being scaled up or down is merely indicative of one particular embodiment. In other embodiments, other entities besides and/or in addition to compute servers may be scaled up or down depending on the predicted resource requirements of scheduled workloads.

The Compute Server 500 supports the following key capabilities: (1) Can execute SQL/SQL Script/Application Function Library (AFL). (2) Runs as a transaction slave associated with the master index server. (3) Contains a persistence layer for supporting temporary tables and large objects (LOBs). (4) Has a data cache to minimize traffic generated by data movement. (5) Allows processing power to be scaled up independent of data movement and backup.

The benefits of the scaling of compute servers may be appreciated by examining a real-world use case. Consider an enterprise company that needs to run an analysis report that is based on a data cube that is built at the end of each quarter. The resource requirements for building this data cube are quite high as the data cube requires the execution of a large number of complex queries that end up fetching data from various remote sources distributed across the company's data centers across the world. In the conventional approach, the relevant systems would have been overprovisioned ahead of time so that there is no shortage of resources during the creation of the data cube.

In an example, one proposed solution allows the above use case to be achieved with significant cost savings due to the following aspects: (1) The serverless architecture ensures that the database servers are brought up only on demand when a query needs to be executed instead of running 24×7. (2) The resource adviser ensures that the compute resources required for the cube creation are made available just-in-time based on the planned workloads.

In summary, the benefits of an example solution are enumerated below: (1) Allows the deployment of data warehousing systems with improved CPU utilization rates of the underlying database systems. (2) Reduces the over-provisioning of the database systems that are used by the data warehousing systems. The key cost savings brought about by the proposed solution lowers the TCO of data warehousing systems to a significant degree.

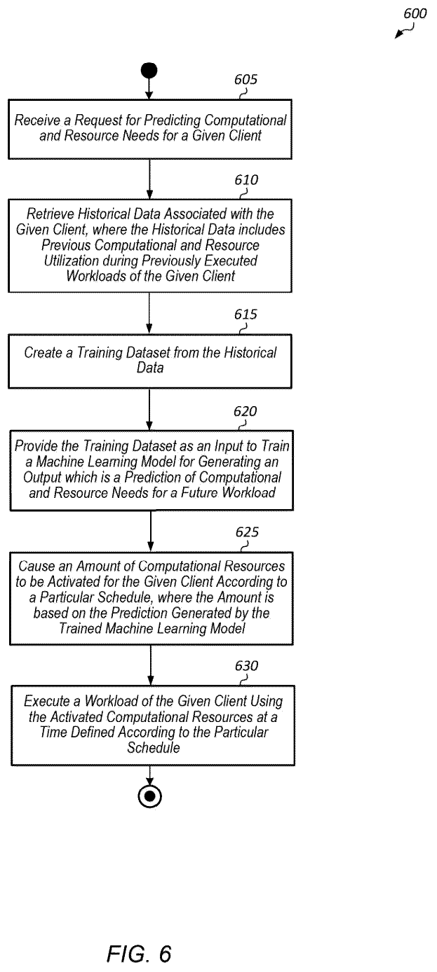

Turning now to FIG. 6, a process for predicting in advance a client's computational and resource needs is depicted, in accordance with one or more embodiments of the current subject matter. At the beginning of the process, a predictive auto-scaling resource adviser (e.g., predictive auto-scaling resource adviser 250 of FIG. 2) receives a request for predicting computational and resource needs for a given client (block 605). The computational and resource needs may include entities such as compute units, compute nodes, database servers, memory, storage, network bandwidth, and so on.

In response to receiving the request, the predictive auto-scaling resource adviser retrieves historical data associated with the given client, where the historical data includes previous computational and resource utilization during previously executed workloads of the given client (block 610). Next, the predictive auto-scaling resource adviser creates a training dataset from the historical data (block 615). In an example, creating the training dataset from the historical data includes converting utilization data from a first format into a second format, where the second format is different from the first format. The first format may be associated with a database for storing the utilization data while the second format may be customized for training a machine learning model.

Then, the predictive auto-scaling resource adviser provides the training dataset as an input to train a machine learning model to generate an output which is a prediction of computational and resource needs for a future workload (block 620). In an embodiment, the machine learning model may be trained to predict the peak memory requirements of the future workload. In another embodiment, the machine learning model may be trained to predict the CPU requirements of the future workload. In other embodiments, the machine learning model may be trained to predict other types of resource needs of the future workload.

Next, the predictive auto-scaling resource adviser causes an amount of computational resources to be activated for the given client according to a particular schedule, where the amount is based on the prediction of computational and resource needs generated as an output by the trained machine learning model (block 625). The amount of computational resources may refer to a specific number of servers, a specific number of compute nodes, a specific amount of memory, and/or other resources. In an example, the amount of computational resources brought up for the given client is equal to the prediction. In another example, the amount of computational resources brought up for the given client is equal to the prediction plus a small margin (e.g., 10%, 20%) as a precautionary measure. In a further example, the given client may define a lower bound of computational and resource needs, and the predictive auto-scaling resource adviser may bring up an amount of computational resources equal to the greater of the lower bound and the prediction generated by the trained machine learning model. Then, a workload of the given client is executed at a time defined according to the particular schedule using the activated computational resources (block 630). After block 630, method 600 may end.

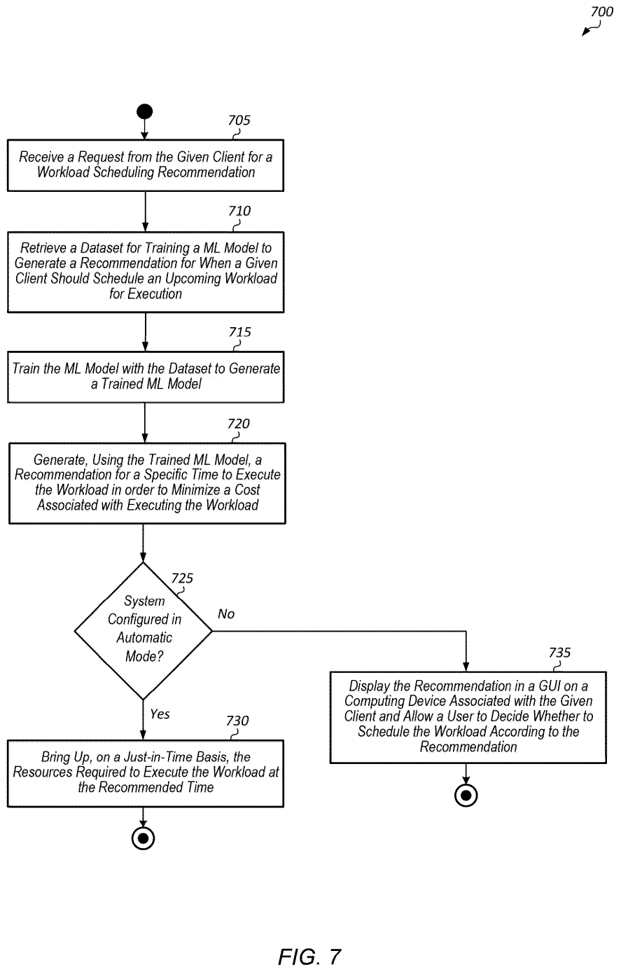

Referring now to FIG. 7, a process for generating recommendations for scheduling the execution of serverless server workloads in order to optimize total cost of ownership is depicted, in accordance with one or more embodiments of the current subject matter. At the start of the process, a system receives a request from a given client for a workload scheduling recommendation (block 705). In an example, the request specifies a time window during which the workload should be scheduled. For example, the given client may specify a particular week at the end of a quarter as the time window for when the workload should be scheduled, and the system may be configured to determine the best time within that particular week for scheduling the workload so as to minimize the cost associated with executing the workload. In some cases, scheduling a workload on the weekend, or scheduling a workload in the early morning hours, when fewer other workloads are being executed, may realize the most cost savings.

In response to receiving the request, the system retrieves a dataset for training a machine learning (ML) model to generate a recommendation for when the given client should schedule an upcoming workload for execution (block 710). The ML model may have any suitable structure and organization, with any number of layers and various numbers of neurons per layer, and may be executed using any of various types of hardware (e.g., ASICs, GPUs, FPGAs, CPUs). The dataset may include first data specific to the given client, second data related to timing and pricing data for executing workloads, and/or third data associated with other workloads that are predicted or known to be scheduled within the same overall time window. Next, the system trains the ML model with the dataset to generate a trained ML model (block 715).

Then, the system uses the trained ML model to generate a recommendation for a specific time to execute the workload in order to minimize a cost associated with executing the workload (block 720). Next, the system determines whether the given client has configured the system for automatically implementing the recommendation (conditional block 725). If the given client has configured the system for automatically implementing the recommendation (conditional block 725, “yes” leg), then the system will bring up, on a just-in-time basis, the resources required to execute the workload at the recommended time (block 730). If the given client has configured the system for automatically implementing the recommendation, this may be referred to as a first mode or as an automatic mode.

Otherwise, if the given client has not configured the system for automatically implementing the recommendation (conditional block 725, “no” leg), then the system may display the recommendation in a graphical user interface (GUI) on a computing device associated with the given client and allow the user to decide whether to schedule the workload according to the recommendation (block 735). If the given client has not configured the system for automatically implementing the recommendation, this may be referred to as a second mode or as a manual mode. In an example, the system may generate multiple ranked recommendations (e.g., a first recommendation, a second recommendation) for display in a GUI on the computing device associated with the given client. A user of the computing device may then select from among the ranked recommendations. In an example, each recommendation may display a cost associated with the recommendation so that the user is able to make an informed decision by comparing the costs associated with the different recommendations. After blocks 730 and 735, method 700 may end.

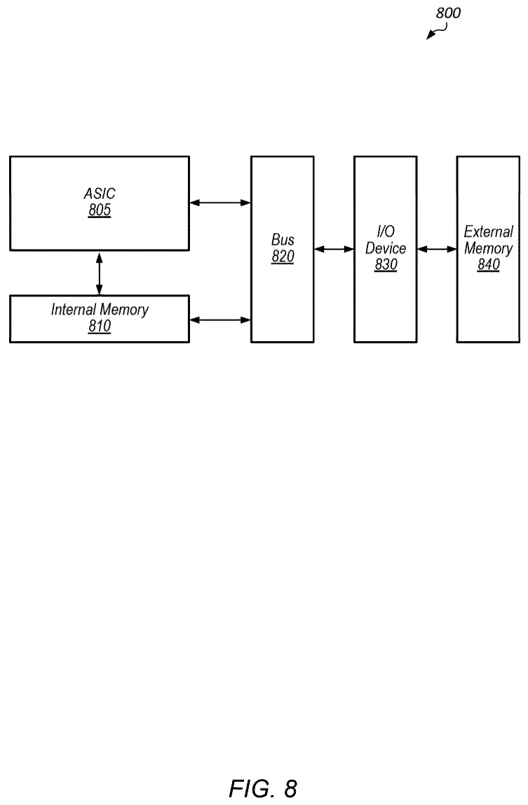

Turning now to FIG. 8, a block diagram of a system 800 for implementing one or more machine learning models is depicted, in accordance with one or more embodiments of the current subject matter. In one embodiment, system 800 may include at least application-specific integrated circuit (ASIC) 805, internal memory 810, bus 820, input/output (I/O) device 830, and external memory 840. System 800 may include other components which are not shown to avoid obscuring the figure. System 800 may be incorporated within a cloud platform (e.g., cloud platform 130 of FIG. 1) or as part of an organization's local computing environment on one or more servers.

ASIC 805 may be configured implement one or more machine learning models in accordance with the subject matter disclosed herein. Examples of machine learning models that may be implemented by ASIC 805 include, but are not limited to, generative pre-trained transformers, neural networks, Generative Adversarial Networks (GANs), and other types of machine learning or artificial intelligence (AI) models. ASIC 805 is representative of any type of circuit or processing unit for implementing one or more machine learning models. In other embodiments, a graphics processing unit (GPU), a tensor processing unit (TPU), or another type of processing unit or circuit may be used in place of or in addition to ASIC 805.

In one embodiment, ASIC 805 includes a plurality of neurons organized in a plurality of layers with neurons from one layer connected to neurons from a subsequent layer optionally with logic circuits for altering, adjusting, and/or applying mathematical functions to the values of the neurons before connecting to the subsequent layer. In an example, the plurality of neurons are organized in an array where each neuron comprises a register (e.g., flip-flop), an input connection, and an output connection. ASIC 805 may be coupled to internal memory 810 for storing input and output values. ASIC 805 and internal memory 810 are coupled to bus 820 which is coupled to I/O device 830. I/O device 830 may be coupled to any number of components including external memory 840. In an example, external memory 840 may have a larger capacity than internal memory 810. Additionally, in an example, external memory 840 may have a slower access capability as compared to internal memory 810 which may be accessed with a relatively higher data rate.

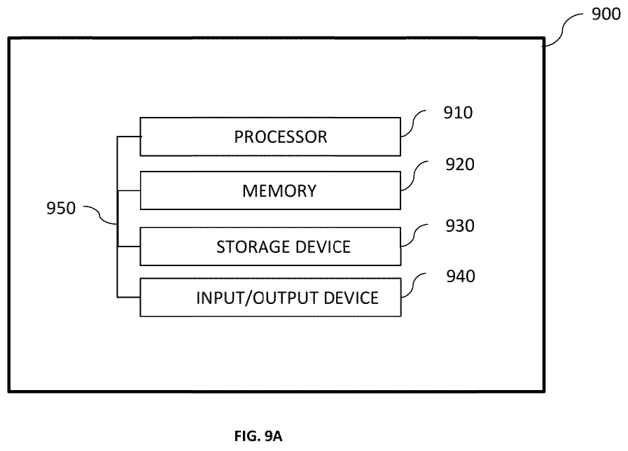

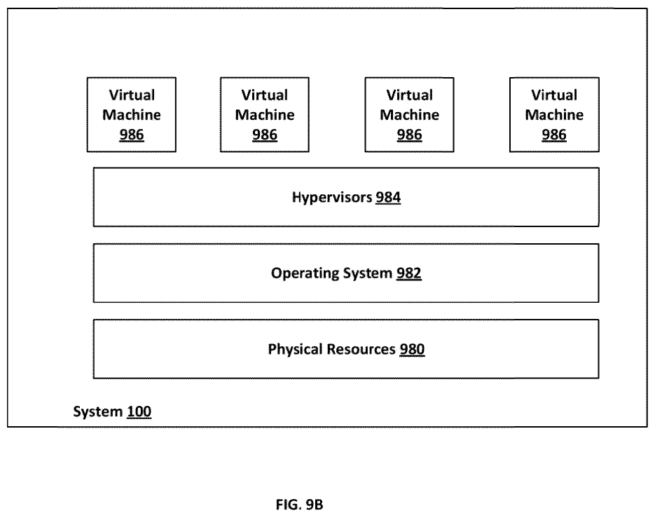

In some implementations, the current subject matter may be configured to be implemented in a system 900, as shown in FIG. 9A. The system 900 may include a processor 910, a memory 920, a storage device 930, and an input/output device 940. Each of the components (e.g., the processor 910, the memory 920, the storage device 930, the I/O device 940) may be interconnected using a system bus 950. The processor 910 may be configured to process instructions for execution within the system 900. In some implementations, the processor 910 may be a single-threaded processor. In alternate implementations, the processor 910 may be a multi-threaded processor. The processor 910 may be further configured to process instructions stored in the memory 920 or on the storage device 930, including receiving or sending information through the input/output device 940. The memory 920 may store information within the system 900. In some implementations, the memory 920 may be a computer-readable medium. In alternate implementations, the memory 920 may be a volatile memory unit. In yet some implementations, the memory 920 may be a non-volatile memory unit. The storage device 930 may be capable of providing mass storage for the system 900. In some implementations, the storage device 930 may be a computer-readable medium. In alternate implementations, the storage device 930 may be a floppy disk device, a hard disk device, an optical disk device, a tape device, non-volatile solid state memory, or any other type of storage device. The input/output device 940 may be configured to provide input/output operations for the system 900. In some implementations, the input/output device 940 may include a touchscreen display capable of displaying graphical user interfaces.

FIG. 9B depicts an example implementation of the system 100 (of FIG. 1). The system 100 may be implemented using various physical resources 980, such as at least one or more hardware servers, at least one storage, at least one memory, at least one network interface, and the like. The system 100 may also be implemented using infrastructure, as noted above, which may include at least one operating system 982 for the physical resources 980 and at least one hypervisor 984 (which may create and run at least one virtual machine 986). For example, each multitenant application may be run on a corresponding virtual machine 986.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable storage medium” refers to any computer program product, apparatus and/or device, such as for example magnetic discs, optical disks, memory, and Programmable Logic Devices (PLDs), used to provide machine instructions and/or data to a programmable processor, including a machine-readable storage medium that receives program instructions as a machine-readable signal. The term “machine-readable signal” refers to any signal used to provide machine instructions and/or data to a programmable processor. The machine-readable storage medium can store such program instructions non-transitorily, such as for example as would a non-transient solid state memory or a magnetic hard drive or any equivalent storage medium. The machine-readable storage medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:
Example 1: A system comprising: an abstractor coupled to one or more computing devices; a serverless service coupled to the abstractor; and a predictive auto-scaling resource adviser coupled to the serverless service, wherein the predictive auto-scaling resource adviser is configured to: automatically scale the serverless service by adding or removing compute nodes based on computational needs of one or more planned workloads; train a first machine learning model to predict a first amount of computational resources expected to be utilized by a first client; and activate a first plurality of compute nodes based on the prediction of the first amount of computational resources expected to be utilized by the first client; wherein the system is configured to execute, with the first plurality of compute nodes, a first workload of the first client.
Example 2: The system of Example 1, wherein the predictive auto-scaling resource adviser is further configured to: train a second machine learning model to predict a second amount of computational resources expected to be utilized by a second client; and activate a second plurality of compute nodes based on the prediction of the second amount of computational resources expected to be utilized by the second client; wherein the system is configured to execute, with the second plurality of compute nodes, a second workload of the second client.
Example 3: The system of any of Examples 1-2, wherein the second amount of computational resources is different from the first amount of computational resources.
Example 4: The system of any of Examples 1-3, wherein the predictive auto-scaling resource adviser is further configured to retrieve first historical data associated with a plurality of historical workloads of the first client.
Example 5: The system of any of Examples 1-4, wherein the predictive auto-scaling resource adviser is further configured to generate a training dataset based on the first historical data.
Example 6: The system of any of Examples 1-5, wherein the predictive auto-scaling resource adviser is further configured to train the first machine learning model by providing the training dataset as an input to the first machine learning model.
Example 7: The system of any of Examples 1-6, wherein the predictive auto-scaling resource adviser is further configured to deactivate the first plurality of compute nodes in response to the first workload being completed.
Example 8: The system of any of Examples 1-7, wherein the predictive auto-scaling resource adviser is further configured to: select whichever is greater between the first amount of computational resources and a lower bound defined by the first client; and determine a quantity of compute nodes to activate based on whichever is greater between the first amount of computational resources and the lower bound defined by the first client.
Example 9: A computer-implemented method comprising: automatically scaling a serverless service by adding or removing compute nodes based on computational needs of one or more planned workloads; training a first machine learning model to predict a first amount of computational resources expected to be utilized by a first client; activating a first plurality of compute nodes based on the prediction of the first amount of computational resources expected to be utilized by the first client; and executing, with the first plurality of compute nodes, a first workload of the first client.
Example 10: The computer-implemented method of Example 9, further comprising: training a second machine learning model to predict a second amount of computational resources expected to be utilized by a second client; activating a second plurality of compute nodes based on the prediction of the second amount of computational resources expected to be utilized by the second client; and executing, with the second plurality of compute nodes, a second workload of the second client.
Example 11: The computer-implemented method of any of Examples 9-10, wherein the second amount of computational resources is different from the first amount of computational resources.
Example 12: The computer-implemented method of any of Examples 9-11, further comprising retrieving first historical data associated with a plurality of historical workloads of the first client.
Example 13: The computer-implemented method of any of Examples 9-12, further comprising generating a training dataset based on the first historical data.
Example 14: The computer-implemented method of any of Examples 9-13, further comprising training the first machine learning model by providing the training dataset as an input to the first machine learning model.
Example 15: The computer-implemented method of any of Examples 9-14, further comprising deactivating the first plurality of compute nodes in response to the first workload being completed.
Example 16: The computer-implemented method of any of Examples 9-15, further comprising: selecting whichever is greater between the first amount of computational resources and a lower bound defined by the first client; and determining a quantity of compute nodes to activate based on whichever is greater between the first amount of computational resources and the lower bound defined by the first client.
Example 17: A non-transitory computer readable storage medium storing instructions, which when executed by at least one data processor, result in operations comprising: automatically scaling a serverless service by adding or removing compute nodes based on computational needs of one or more planned workloads; training a first machine learning model to predict a first amount of computational resources expected to be utilized by a first client; activating a first plurality of compute nodes based on the prediction of the first amount of computational resources expected to be utilized by the first client; and executing, with the first plurality of compute nodes, a first workload of the first client.
Example 18: The non-transitory computer readable storage medium of Example 17, wherein the operations further comprise retrieving first historical data associated with a plurality of historical workloads of the first client.
Example 19: The non-transitory computer readable storage medium of any of Examples 17-18, wherein the operations further comprise generating a training dataset based on the first historical data.
Example 20: The non-transitory computer readable storage medium of any of Examples 17-19, wherein the operations further comprise training the first machine learning model by providing the training dataset as an input to the first machine learning model.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A system comprising:
an abstractor coupled to one or more computing devices;
a serverless service coupled to the abstractor; and
a predictive auto-scaling resource adviser coupled to the serverless service, wherein the predictive auto-scaling resource adviser is configured to:
automatically scale the serverless service by adding or removing compute nodes based on computational needs of one or more planned workloads;
train a first machine learning model to predict a first amount of computational resources expected to be utilized by a first client; and
activate a first plurality of compute nodes based on the prediction of the first amount of computational resources expected to be utilized by the first client;
wherein the system is configured to execute, with the first plurality of compute nodes, a first workload of the first client.

2. The system of claim 1, wherein the predictive auto-scaling resource adviser is further configured to:
train a second machine learning model to predict a second amount of computational resources expected to be utilized by a second client; and
activate a second plurality of compute nodes based on the prediction of the second amount of computational resources expected to be utilized by the second client;
wherein the system is configured to execute, with the second plurality of compute nodes, a second workload of the second client.

3. The system of claim 2, wherein the second amount of computational resources is different from the first amount of computational resources.

4. The system of claim 1, wherein the predictive auto-scaling resource adviser is further configured to retrieve first historical data associated with a plurality of historical workloads of the first client.

5. The system of claim 4, wherein the predictive auto-scaling resource adviser is further configured to generate a training dataset based on the first historical data.

6. The system of claim 5, wherein the predictive auto-scaling resource adviser is further configured to train the first machine learning model by providing the training dataset as an input to the first machine learning model.

7. The system of claim 1, wherein the predictive auto-scaling resource adviser is further configured to deactivate the first plurality of compute nodes in response to the first workload being completed.

8. The system of claim 1, wherein the predictive auto-scaling resource adviser is further configured to:
select whichever is greater between the first amount of computational resources and a lower bound defined by the first client; and
determine a quantity of compute nodes to activate based on whichever is greater between the first amount of computational resources and the lower bound defined by the first client.

9. A computer-implemented method comprising:
automatically scaling a serverless service by adding or removing compute nodes based on computational needs of one or more planned workloads;
training a first machine learning model to predict a first amount of computational resources expected to be utilized by a first client;
activating a first plurality of compute nodes based on the prediction of the first amount of computational resources expected to be utilized by the first client; and
executing, with the first plurality of compute nodes, a first workload of the first client.

10. The computer-implemented method of claim 9, further comprising:
training a second machine learning model to predict a second amount of computational resources expected to be utilized by a second client;
activating a second plurality of compute nodes based on the prediction of the second amount of computational resources expected to be utilized by the second client; and
executing, with the second plurality of compute nodes, a second workload of the second client.

11. The computer-implemented method of claim 10, wherein the second amount of computational resources is different from the first amount of computational resources.

12. The computer-implemented method of claim 9, further comprising retrieving first historical data associated with a plurality of historical workloads of the first client.

13. The computer-implemented method of claim 12, further comprising generating a training dataset based on the first historical data.

14. The computer-implemented method of claim 13, further comprising training the first machine learning model by providing the training dataset as an input to the first machine learning model.

15. The computer-implemented method of claim 9, further comprising deactivating the first plurality of compute nodes in response to the first workload being completed.

16. The computer-implemented method of claim 9, further comprising:
selecting whichever is greater between the first amount of computational resources and a lower bound defined by the first client; and
determining a quantity of compute nodes to activate based on whichever is greater between the first amount of computational resources and the lower bound defined by the first client.

17. A non-transitory computer readable storage medium storing instructions, which when executed by at least one data processor, result in operations comprising:
automatically scaling a serverless service by adding or removing compute nodes based on computational needs of one or more planned workloads;
training a first machine learning model to predict a first amount of computational resources expected to be utilized by a first client;
activating a first plurality of compute nodes based on the prediction of the first amount of computational resources expected to be utilized by the first client; and
executing, with the first plurality of compute nodes, a first workload of the first client.

18. The non-transitory computer readable storage medium of claim 17, wherein the operations further comprise retrieving first historical data associated with a plurality of historical workloads of the first client.

19. The non-transitory computer readable storage medium of claim 18, wherein the operations further comprise generating a training dataset based on the first historical data.

20. The non-transitory computer readable storage medium of claim 19, wherein the operations further comprise training the first machine learning model by providing the training dataset as an input to the first machine learning model.
